(19) United States
(12) Patent Application Publication
(10) Pub. No.: US 2019/0378381 A1
(43) Pub. Date: Dec. 12, 2019

(54) Method for notifying a user via a computer system

(71) Applicant: PEGATRON CORPORATION, TAIPEI CITY (TW)

(72) Inventor: Bo-Sen Chang, TAIPEI CITY (TW)

(21) Appl. No.: 16/420,131

(22) Filed: May 22, 2019

(30) Foreign Application Priority Data
Jun. 12, 2018 (TW) 107120102

(51) Int. Cl. G08B 5/38; G05B 15/02; G06F 13/20

(52) U.S. Cl. CPC G08B 5/38; H04L 51/24; G06F 13/20; G05B 15/02

(57) ABSTRACT

A computer system has at least one indication light, an application, an operating system (OS), a basic input/output system (BIOS) and a light controller. In response to an event of the application program, an application programming interface (API) of the operating system transmits a light indication to the operating system. In response to the light indication, an instrumentation of the operating system transmits a control command to the BIOS. In response to the control command, the BIOS transmits a light command to the light controller. The light controller controls the at least one indicator light to emit light in a predetermined manner according to the light command.

### CROSS REFERENCE TO RELATED APPLICATION

This application claims the benefit of Taiwan (Republic of China) application No. 107120102, filed on Jun. 12, 2018, the contents of which are incorporated herein in their entirety.

### BACKGROUND

### 1. Technology Field

The present invention relates to a method for notifying a user by a computer system, and more particularly to a method for notifying a user by using an indicator light of a computer system.

### 2. Description of the Prior Art

In a computer system, users are often notified through sounds. For example, when an email is received, the computer system sends a specific sound or voice through its speaker to notify the user of the reception of a new email. However, for users with hearing impairments, and for users who set the computer system in a silent mode, the above-mentioned method of notifying the users through sound cannot effectively reach the purpose of alerting the user.

### SUMMARY

The present invention mainly provides a method for notifying a user by using an indicator light of a computer system, so that the user can immediately know the current state of the computer system according to the illumination manner of the indicator light.

An embodiment of the present invention discloses a method for notifying a user by a computer system. The computer system comprises an application program, an operating system, a basic input/output system (BIOS), at least one indicator light, and a light controller. The method comprises: in response to an event of the application program, transmitting a light indication to the operating system through an application programming interface (API) of the operating system; in response to the light indication, transmitting a control command to the BIOS by an instrumentation of the operating system; in response to the control command, transmitting a light command to the light controller by the BIOS; and controlling the at least one indicator light to emit light in a specific way according to the light command by the light controller.

According to the method of the present invention, when the application program generates a predetermined event, information of the predetermined event would be converted into a light command through the OS, the BIOS and the light controller to control the indicator light(s) to emit light. In this way, when a predetermined event occurs in the computer system (such as receiving a new email or message), the user can know the event instantly according to the illumination manner of the indicator light(s). Therefore, for a user with hearing impairment or a user who switches the computer system to the silent mode, the user can still be notified.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system for implementing a method of an embodiment of the present invention.

FIG. 2 is a flow chart of a method according to an embodiment of the present invention.

### DETAILED DESCRIPTION

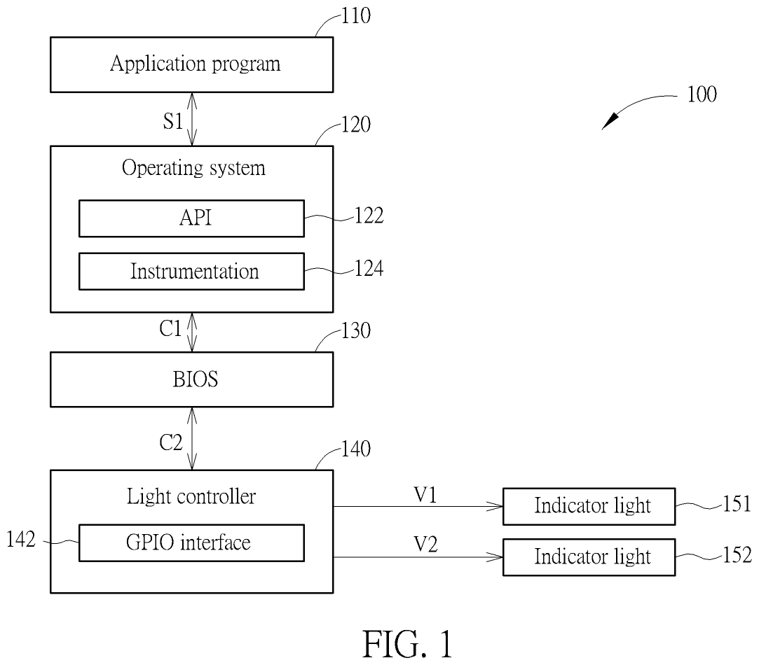

Please refer to FIG. 1. FIG. 1 is a functional block diagram of a computer system 100 for implementing a method of an embodiment of the present invention. In order to emphasize the characteristics of the present invention, the computer system 100 in FIG. 1 is simplified to draw only the parts directly related to the present invention, and the components or structures (such as memory, disk drive, screen, keyboard, etc.) of the computer system 100 which are not directly related to the present invention and do not affect the implementation of the present invention are not shown in FIG. 1. An application program 110 and an operating system (OS) 120 are installed in the computer system 100, and the computer system 100 comprises a basic input/output system (BIOS) 130, a light controller 140, and indicator lights 151 to 152. When the computer system 100 is powered on, the BIOS 130 will be loaded and executed first to complete the initialization of the computer system 100. After completing the loading and execution of the BIOS 130, the computer system 100 loads and executes the OS 120. In the embodiment, the OS 120 can be a Windows operating system of Microsoft Corporation, but the invention is not limited thereto. After the computer system 100 completes the loading of the OS 120, the application program 110 can be executed in the environment of the OS 120. In the embodiment, the application program 110 is an instant messaging software (such as Skype, Line, WeChat, etc.), but the invention is not limited thereto. For example, in another embodiment of the present invention, the application program 110 can be an email software for sending and receiving emails.

When the application program 110 generates a predetermined event, for example, when a message is received or a new email is received, the application program 110 responds to the event by using an application programming interface (API) 122 of the OS 120 to transmit a light indication S1 to the OS 120 so as to notify the OS 120 of the occurrence of the above event. Then, the OS 120 transmits a control command C1 to the BIOS 130 through an instrumentation 124 of the OS 120 in response to the light indication S1. In the embodiment, the instrumentation 124 is Windows Management Instrumentation (WMI) of Microsoft's Windows operating system, but the invention is not limited thereto. After the BIOS 130 receives the control command C1, the BIOS 130 transmits a light command C2 to the light controller 140 through a predetermined channel in response to the control command C1. The predetermined channel is, for example, a 45-port of the light controller 140. In addition, in the embodiment, the computer system 100 is a laptop, and the light controller 140 is an embedded controller (EC) of the laptop. In another embodiment of the present invention, the computer system 100 is a desktop computer, and the light controller 140 is a super input/output (super I/O; SIO) chip of the desktop computer.

When the light controller 140 receives the light command C2 from the BIOS 130 the light controller 140 controls the indicator lights 151 and/or 152 to emit light in a predetermined manner according to the light command C2. Furthermore, the number of indicator lights controlled by the light controller 140 may be a single one, two or more indicator lights, and although only two indicator lights 151 and 152 are shown in FIG. 1, in other embodiments of the invention, the method of the invention is applied to a computer system for controlling three or more indicator lights. In the example of controlling the single indicator light 151, when the light controller 140 receives the light command C2, the light controller 140 outputs a voltage signal V1 to the indicator light 151 according to the light command C2, so that the indicator light 151 emits light according to the voltage signal V1. The waveform of the voltage signal V1 is determined by the light controller 140 according to the light command C2 so that the indicator light 151 would emit light in a predetermined manner. The predetermined manner may be, for example, but not limited to, flashing at a predetermined frequency (e.g., two flashes, three flashes or more flashes per second), light on for a long duration (e.g., 0.3 seconds) followed by flashes (e.g., light on for 0.1 seconds, then light off for 0.1 seconds, light on for another 0.1 seconds, and light off for another 0.1 seconds), etc. In another embodiment of the present invention, the indicator lights 151 and/or 152 may be a power indicator light of the computer system 100. In another embodiment of the present invention, when the light controller 140 simultaneously controls the plurality of indicator lights 151 and 152 to emit light according to the light command C2, the indicator lights 151 and 152 is capable of emitting respective lights in different colors. The light controller 140 outputs the voltage signals V1 and V2 to the indicator lights 151 and 152 respectively, so that the indicator lights 151 and 152 emit light according to the voltage signals V1 and V2 respectively. In addition, the indicator lights 151 and 152 may each be composed of one light emitting diode (LED). However, the invention is not limited thereto. The indicator lights 151 and 152 may be other elements capable of emitting light. In an embodiment of the invention, the light controller 140 outputs the voltage signal V1 to the indicator light 151 and/or outputs the voltage signal V2 to the indicator light 152 through a general purpose input/output (GPIO) interface 142 to control the indicator lights 151 and/or 152 to emit light in the foresaid predetermined manner.

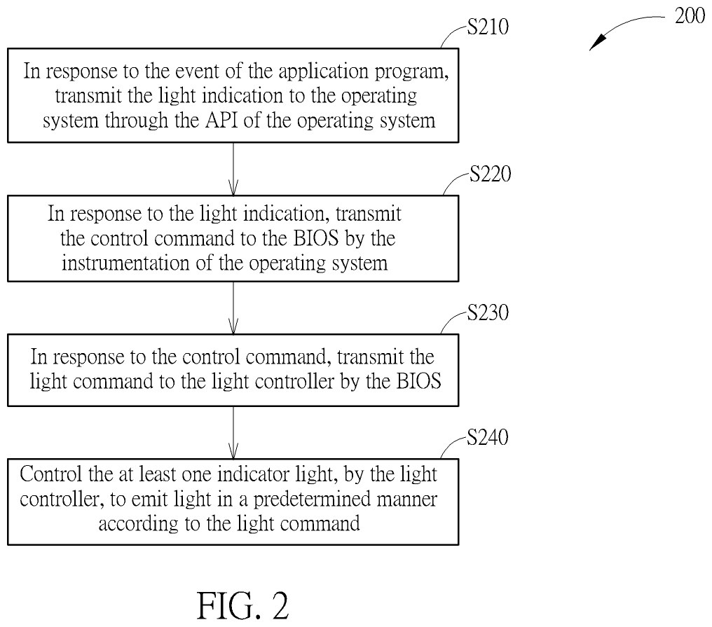

Please refer to FIG. 2. FIG. 2 is a flow chart of a method 200 according to an embodiment of the present invention. The method 200 comprises the following steps:

Step S210: in response to an event of the application program 110, transmit a light indication S1 to the OS 120 through the API 122 of the OS 120;

Step S220: in response to the light indication S1, transmit the control command C1 to the BIOS 130 by the instrumentation 124 of the OS 120;

Step S230: in response to the control command C1, transmit the light command C2 to the light controller 140 by the BIOS 130; and

Step S240: control the indicator lights 151 and/or 152, by the light controller 140, to emit light in a predetermined manner according to the light command C2.

In summary, according to the method of the present invention, when the application program generates a predetermined event, information of the predetermined event would be converted into a light command through the OS, the BIOS and the light controller to control the indicator light(s) to emit light. In this way, when the predetermined event occurs in the computer system (such as receiving a new email or message) the user can know the event instantly according to the illumination approaches of the indicator light (s). Therefore, for a user with hearing impairment or a user who switches the computer system to the silent mode, the user can be effectively notified.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for notifying a user by a computer system, the computer system comprising an application program, an operating system, a basic input/output system (BIOS), at least one indicator light, and a light controller, the method comprising:
in response to an event of the application program, transmitting a light indication to the operating system through an application programming interface (API) of the operating system;
in response to the light indication, transmitting a control command to the BIOS by an instrumentation of the operating system;
in response to the control command, transmitting a light command to the light controller by the BIOS; and
controlling the at least one indicator light to emit light in a predetermined manner according to the light command by the light controller.

2. The method of claim 1, wherein the BIOS transmits the light command to the light controller of the computer system through a predetermined channel in response to the control command.

3. The method of claim 1, wherein the computer system is a laptop, and the light controller is an embedded controller of the laptop.

4. The method of claim 1, wherein the computer system is a desktop computer, and the light controller is a super input/output (super I/O; SIO) chip of the desktop computer.

5. The method of claim 1, wherein the operating system is a Microsoft Windows operating system, and the instrumentation is Windows Management Instrumentation (WMI).

6. The method of claim 1, wherein the light controller controls the at least one indicator light to emit light in the predetermined manner via a general purpose input/output (GPIO) interface.

7. The method of claim 1, wherein the predetermined manner enables the at least one indicator light to flash.

8. The method of claim 1, wherein the predetermined manner enables the at least one indicator light to light in a long duration followed by flashes.

9. The method of claim 1, wherein the at least one indicator light comprises a plurality of indicator lights.

10. The method of claim 1, wherein the application program is an instant messaging software, and the event is the instant messaging software receiving a message.

11. The method of claim 1, wherein the application program is an email software, and the event is the email software receiving an email.
